(19) United States
(12) Patent Application Publication
(10) Pub. No.: US 2006/0158894 A1
(43) Pub. Date: Jul. 20, 2006

(54) Motor vehicle reverse assistance light

(76) Inventor: A-Gi Chou, Tao-Yuan Hsien (TW)

Correspondence Address: Meng-Tsuey, Pan, P. O. Box 1-252, Sanchung City, TW

(21) Appl. No.: 10/738,348

(22) Filed: Dec. 15, 2003

(30) Foreign Application Priority Data
Jan. 21, 2003 (TW) 92201101

(51) Int. Cl. F21V 33/00; F21S 8/10

(52) U.S. Cl. 362/506; 362/505; 362/545; 362/540; 362/549

(57) ABSTRACT

A motor vehicle reverse assistance light comprised of a housing, a base, a socket, a lighting emitting diode (LED) bulb cluster, and a lamp hood. The housing is an inverted U-shaped shell having a receptacle and a locating tab formed inside, a threaded sleeve at one end, and a stepped seating rim in the threaded sleeve. The base is a rectangular-shaped member having a rod and an arcuate groove formed on it. The socket has wire leads disposed on one end. The lamp hood is a screw-on tube with a transparent outer cover. The LED bulb cluster is set onto the socket, which is next inserted up to the stepped seating rim inside the threaded sleeve of the housing shell and the lamp hood is fastened onto the threaded sleeve. Finally, the wire leads of the socket are routed through the rod of the base and, furthermore, out from a base member. The rounded annular tip at the distal end of the rod is fitted (engaged) inside the receptacle such that it is rotatably conjoined to the housing shell and the locating tab within the housing shell is situated in the arcuate groove on the base member such that it is slidable therein. With the assembly of the motor vehicle reverse assistance light of the present invention completed, it can be installed on the two rear fenders, the upper extent of the fenders, or a point near the chassis of a motor vehicle to thereby furnish illumination during backing up or tire changes and tire pressure replenishing. As positioned on the base, the housing is freely rotatable to the left and right from 0-90 degrees to adjust the direction of illumination.

### BACKGROUND OF THE INVENTION

1) Field of the Invention

The invention herein relates to automotive accessories, specifically a motor vehicle reverse assistance light designed for installation on the two rear fenders or upper extent of the fenders of a vehicle (such as a sedan and vans, etc.) that is utilized to provide illumination when backing up in reverse gear or as a variable direction light source for viewing the front or rear tires at night.

2) Description of the Prior Art

Conventional motor vehicles (such as sedans and vans, etc.) are currently not equipped with utility lights that aid in driving such vehicles to the rear. In the past, driving backward along narrow streets, lanes, and alleys was difficult in just a few situations because there were less vehicles. However, there are now many more vehicles; virtually every family and household has a car or motorcycle. Furthermore, both sides of streets, lanes, and alleys are often filled with parked autos and mopeds, with the situation becoming especially serious at night. As such, without a person directing a vehicle that is backing up to park along a constricted street, lane, or alley, the process is troublesome and slow, and risks bumping into cars or motorcycles already parked along the curbing. In view of this problem, the applicant of the invention herein researched and developed the motor vehicle reverse assistance light of the invention herein.

### SUMMARY OF THE INVENTION

The objective of the invention herein is to provide a motor vehicle reverse assistance light that automatically illuminates the area of the two rear tires when a vehicle so-equipped is driven in reverse gear to facilitate backing up with greater ease and safety.

Another objective of the invention herein is to provide a motor vehicle reverse assistance light that can be switched on by shifting into reverse gear when a vehicle so-equipped has a punctured tire or insufficient tire pressure to illuminate the area of either the two rear wheels or the two front wheels, thereby precluding the necessity of using another lighting fixture (equipment) or a flash light to replace the tire or replenish air pressure; similarly, the present invention can also serve as an illumination source for vehicle inspection (repair) and other tasks.

### BRIEF DESCRIPTION OF THE DRAWINGS

FIG. 1 is an orthographic drawing of the invention herein, as viewed from the front.

FIG. 2 is an orthographic drawing of the invention herein, as viewed from the left side.

FIG. 3 is an isometric drawing of the invention herein shown in a cross-sectional perspective.

FIG. 4 is an exploded drawing of the invention herein, with the housing portion shown cross-sectionally.

FIG. 5 is an orthographic drawing of the invention herein that illustrates the 90-degree rotation of the housing forward and to the right and then rearward to the left, a reference line indicating the 45-degree mark passed during rotation to the left and the right.

FIG. 6 is an orthographic drawing of the invention herein installed for utilization.

### DETAILED DESCRIPTION OF THE INVENTION

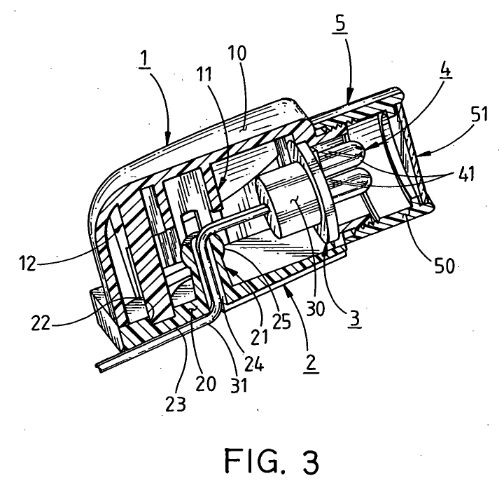

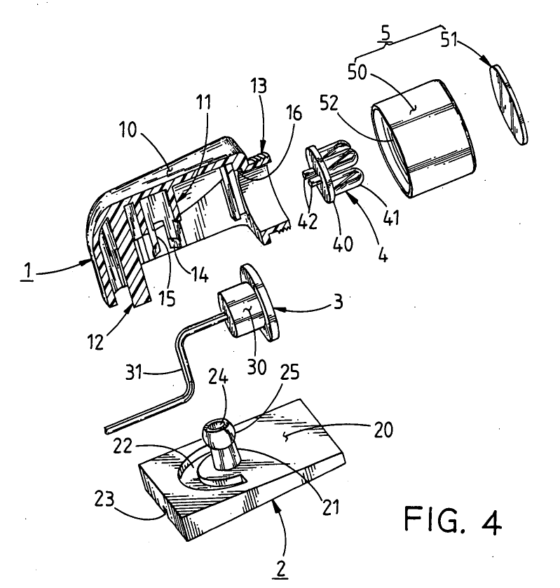

Referring to FIG. 3 and FIG. 4, the motor vehicle reverse assistance light of the invention herein is comprised of a housing 1, a base 2, a socket 3, an LED bulb cluster 4, and a lamp hood 5. The wire leads 31 and LED bulb cluster 4 are products that are currently available for sale on the market and the remaining structural components molded of plastic. Wherein, the housing 1 is a molded inverted U-shaped shell 10; in addition to a locating tab 12, the shell 10 consists of a molded receptacle 11 having a semicircular retaining edge 14 and a pair or more slots 15 along its opening; a hollow threaded sleeve 13 is molded in one end of the said shell 10 to enable the fastening on of the said lamp hood 5; a stepped seating rim 16 is molded inside the said threaded sleeve 13 for the insertion of the said socket 3. The said base 2 is a rectangular-shaped member 20 of one-piece molded construction; formed on its extreme upper surface is a rod 21 with a rounded annular tip 25 at the distal end and a passage 24 through the center and, furthermore, an arcuate groove 22 that are respectively aligned with the receptacle 11 and the locating tab 12 of the said housing 1 shell 10, thereby enabling the rotatable planting of the said rod 21 into the receptacle 11 in the housing 1 shell 10 and the movable placement of the locating tab 12 of the said shell 10 within the said arcuate groove 22 (as shown in FIG. 3), the arrangement utilized to limit the rotation range of the housing 1 on the base 2 to 90 degrees to the left and to the right; the said socket 3 is a top hat-shaped fixture 30 having a pair of wire leads 31 disposed on its rear side, the said wire leads 31 embedded into the fixture 30 at the same time the said fixture 30 is molded to prevent easy dislodging and separation and, furthermore, a pair of docking holes (not shown in the drawings) are formed in the front surface of the said fixture 30 for the insertion of the LED bulb cluster 4. The said LED bulb cluster 4 consists of four three-volt LEDs 41 connected in series and mounted on a planar member 40 for circuiting to a 12-volt automotive storage battery, and disposed on the rear side of the said planar member 40 are a pair of pins 42 that are inserted into the socket 3. The said hood 5 is a screw-on tube 50 having a transparent outer cover 51 attached to its anterior end, all of which are of single-injection molded plastic construction. Additionally, a section of internal threads 52 are molded inside the posterior end of the said screw-on tube 50 to enable fastening onto the threaded sleeve 13 at one extremity of the housing 1 shell 10 and a reliefed ring 53 (as shown in FIG. 3) is molded inside the opposite extremity of the said screw-on tube 50 for the snug-fitting or ultrasonic conjoinment of the said transparent outer cover 51.

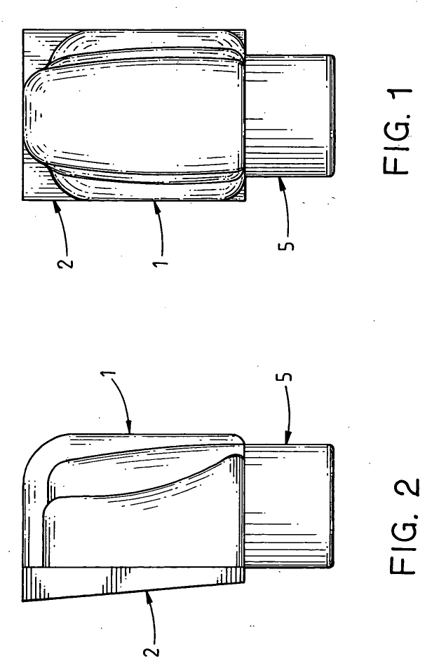

When the motor vehicle reverse assistance light of the invention herein is assembled, the LED bulb cluster 4 is first set onto the socket 3, the said socket 3 having the LED bulb cluster 4 installed is inserted up to the stepped seating rim 16 inside the threaded sleeve 13 at one extremity of the housing 1 shell 10, following which the lamp hood 5 is fastened onto the said threaded sleeve 13; finally, the wire leads 3 on the said socket 3 are routed through the passage 24 centered in the rod 21 of the base 2 member 20 and, furthermore, out from the said member 20, after which the rounded annular tip 25 at the distal end of the rod 21 is fitted (engaged) onto the semicircular retaining edge 14 inside the receptacle 11 such that it is rotatably conjoined to the housing 1 shell 10 and the locating tab 12 within the said housing 1 shell 10 is placed into the arcuate groove 22 on the said base 2 member 20 such that it is slidable therein, which thereby completes the assembly of the motor vehicle reverse assistance light of the invention herein (the exterior view of which is shown in FIG. 2, with the structural assembly details indicated in FIG. 3), the base 2 member 20 providing for direct installation (by adhesive or fasteners) on the two rear fenders 61, the upper extent of the said fenders 61, or a point near the chassis of a motor vehicle 6 to thereby furnish illumination during backing up or tire changes and tire pressure replenishing.

When the motor vehicle reverse assistance light of the invention herein is installed on the motor vehicle 6, one of the wire leads 31 emerging from the base 2 member 20 must be connected to electrical ground (a bare metal section of the chassis) and the remaining wire lead connected to the reverse light circuit (not shown in the drawings) of the motor vehicle 6 before the installation is fully complete. Since the said wire leads 31 are routed through the said base 2 member 20, which may be installed on the two rear fenders 61, the upper extent of the said fenders 61, or a point near the chassis of a motor vehicle 6, a channel 23 (as shown in FIG. 3 and FIG. 4) that is contiguous with the passage 24 through the center of the rod 21 is formed along the lower side of said member 20 when the said member 20 is molded to facilitate the routing of the wire leads 31 from the rear side of the socket 3 to the reverse light switch and electrical ground connections.

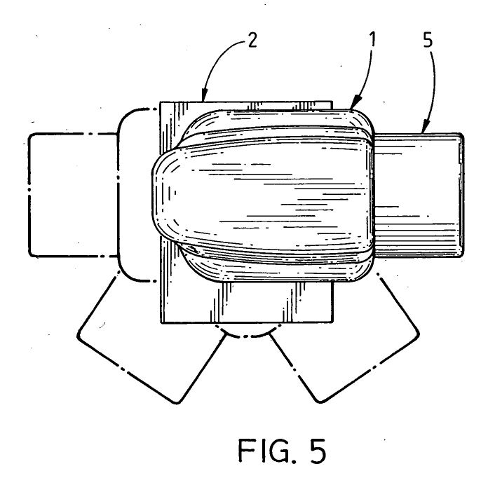

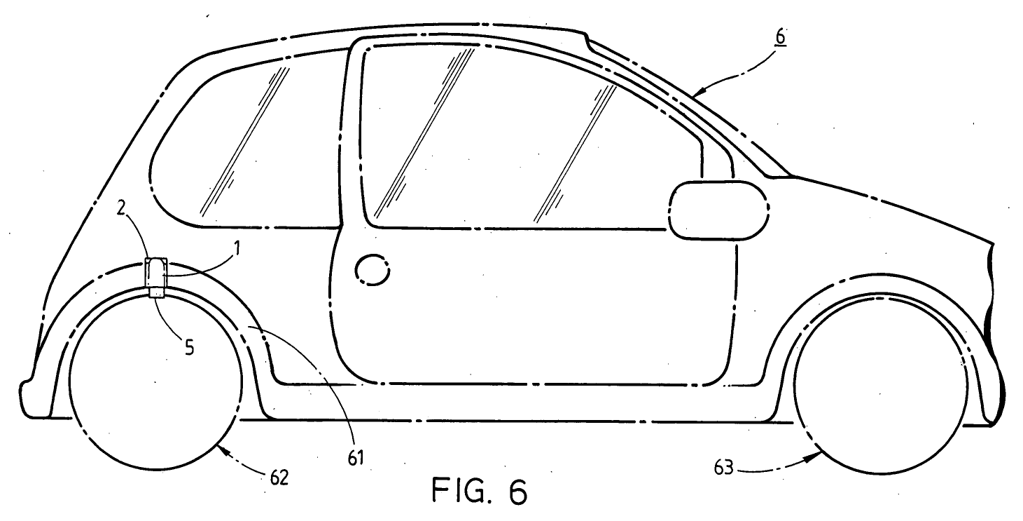

Since the wire leads 31 of the motor vehicle reverse assistance light of the invention herein are connected to the reverse light circuit of the motor vehicle 6, when the said motor vehicle 6 is shifted into reverse gear to drive towards the rear, current is supplied to illuminate the LED bulb cluster 4 in the motor vehicle reverse assistance light of the present invention, which thereby facilitates backing up by affording an effective means of avoiding parked cars and motorcycles as well as other objects and pedestrians situated along the sides of streets or roads. In the event the said motor vehicle 6 has a punctured tire, the vehicle can be parked and then shifted into reverse gear to switch on the LED bulb cluster 4 of the motor vehicle reverse assistance light of the invention herein to provide illumination in the proximity of the two rear tires 62 to convenience tire replacement; if a front tire 63 goes flat, the housing 1 of the motor vehicle reverse assistance light of the invention herein, as indicated in FIG. 5, can be rotated 90 degrees to the right (That is, if the present invention is installed on the right side of the motor vehicle 6, as shown in FIG. 6; if installed on the left side, then the housing 1 is rotated 90 degrees to the left.) to illuminate the front tire 63 location to similarly facilitate the replacement of the front tire 63; and by the same principle, the said housing 1 can be rotated to the left or the right to effect minor angular adjustment (as depicted by the invisible lines in FIG. 5) for more convenient front tire 62 replacement or air pressure replenishment.

1. A motor vehicle reverse assistance light comprising:
a housing which is an inverted U-shaped shell utilized to hold a socket;
a base which is a rectangular-shaped member that includes:
a rod and an arcuate groove formed on the said rectangular-shaped member of the said base;
the said rod on the said base member which is engaged within the said receptacle in the said housing shell so that it is rotatably conjoined to it;
a locating tab in the said housing shell situated in the said arcuate groove on the said base member;
a lamp hood that is a screw-on tube with a transparent outer cover fastened onto a threaded sleeve, which further consists of:
a receptacle and a locating tab formed inside the said shell;
a threaded sleeve at one end of the said shell; and
an LED bulb cluster set onto the said socket, which is then inserted inside the said threaded sleeve of the said housing.

2. As mentioned in claim 1 of the motor vehicle reverse assistance light of the invention herein, the said receptacle in the said housing shell includes:
a semicircular retaining edge and a pair or more slots along its opening;
the said rod on the said base member consisting of:
a rounded annular tip at the distal end;
a passage through the center;
the said rounded annular tip on the said rod of the said base member which is rotatably coupled by means of the said semicircular retaining edge along the opening of the said receptacle in the said housing shell; and
the said wire leading on the said socket which are routed through the said passage centered in the said rod of the said base member.

3. As mentioned in claim 1 of the motor vehicle reverse assistance light of the invention herein, a channel is formed along the lower side of said base member that proceeds along one side of the said member up to the said passage in the center of the said rod on the said member to facilitate the routing of the said wire leads from the rear side of the said socket to the reverse light switch and electrical ground connections.
